(19) United States
(12) Patent Application Publication
(10) Pub. No.: US 2014/0222694 A1
(43) Pub. Date: Aug. 7, 2014

(54) COMPENSATION EVALUATING SUPPORT SYSTEM FOR JUDGMENT OF PATENT INFRINGEMENT

(71) Applicant: NATIONAL CHENG KUNG UNIVERSITY, Tainan City (TW)

(72) Inventors: Chao-Chun CHEN, Tainan City (TW); Chun-Yu CHEN, Donggang Township (TW); Gen-Ming GUO, Kaohsiung City (TW); Ding-Chau WANG, Tainan City (TW)

(73) Assignee: NATIONAL CHENG KUNG UNIVERSITY, Tainan City (TW)

(21) Appl. No.: 13/761,878

(22) Filed: Feb. 7, 2013

(51) Int. Cl. G06Q 50/18; G06Q 40/00

(52) U.S. Cl. CPC G06Q 50/184; G06Q 40/00
USPC 705/310

(57) ABSTRACT

A compensation evaluating support system for judgment of patent infringement includes an electronic device respectively and signally connected to an input interface which serves to input an infringement data and an output interface which serves to output a judging result, a database module for saving the infringement data, a machine-readable format module automatically formatting the infringement data, a factor screening module inputting a weighting questionnaire data with decision factors via the input interface and analyzing the weighting questionnaire data to generate a weighting coefficient which is thence stored in the database module, a decision support module for analyzing the infringement data and the weighting coefficient to generate the judging result, and a decision verification module for inputting a use questionnaire data via the input interface and analyzing the use questionnaire data to update the decision factors.

### BACKGROUND OF THE INVENTION

1. Field of the Invention

The present invention relates to a compensation evaluating support system for judgment of patent infringement, more particularly a supporting application system as a compensation evaluation reference in a patent infringement appeal adapted to judges, prosecutors, lawyers, judicial officials, juridical students, and the public.

2. Description of the Related Art

Recently, the examinations of patent infringement cases in the court are individually judged by judges in light of a free evaluation of the evidence. However, due to different professions and subjectivities, the judges may make different judging results that may be far away from what the public expects. If the regulation is frequently changed and the judge fails to catch a prompt new regulation, misjudgments as a result of error regulations as cited are easily incurred. Especially, the patent infringement cases, which are not as simple as civil cases and criminal cases, usually involve in a technical point and require other reference tools to help the case examination and judgment. A disclosure as disclosed by Taiwan published patent no. 200947335 on 2009 Nov. 16 and titled by “an evaluation system and method for responsibility insurance of patent infringement”. This disclosure mainly discloses an underwriting data evaluation module of patent infringement responsibility to evaluate the preliminary insurability of the patent infringing product, comprising steps of: (1) inputting a potential patent infringing product and/or a process; and (2) determining whether the patent infringing product and/or a process can possess a preliminary insurability for us, namely, checking whether the product and the process reach the predetermined basic underwriting condition and evaluating if the preliminary insurability is constituted. If the result is positive, conduct the next step, but if it is negative, stop the operation. A responsibility risk evaluation module of patent infringement is applied to evaluate the risk of the responsibility of the patent infringement, comprising steps of: (1) inputting the underwriting data of a subject product and/or a subject process. The data is provided by the insured and/or the insurer; (2) acquiring a risk evaluation data of a patent technique similar to the subject product and/or the subject process, which renders the product and/or the process subject to a potential infringing possibility. The risk evaluation data collects information based on the patent regulations and elements stipulated by patent submitting countries and other subjective as well as objective conditions and establish a predetermined standard; and (3) determining the potential infringing risk of the product and/or the process according to the risk evaluation data, checking whether the determination reaches the predetermined standard, and deciding whether the risk of the product and/or the process is affordable. An evaluation module of the premium is applied to evaluate the premium and insured amount of the product and/or the process, comprising steps of: (1) inputting the underwriting data and the risk evaluation data of a product and/or a process; (2) determining or amending the premium and insured amount according to the risk revaluation data.

The above disclosure is mainly applied to evaluate the risk of the patent infringement but is not applied to aid the judgment of the patent infringement.

A further disclosure as disclosed by Taiwan published patent no. 201207761 on 2012 Feb. 16 and titled by “a determining system of patent infringement”. This disclosure mainly discloses a plurality of technical feature data, a related technical feature data for recording a correlation of superordinate elements and related subordinate elements of the plurality of technical feature data, a claiming data, a related claims-technical feature data for recording a relationship between the claiming data and the technical feature data, an analyzing object data, a related analyzing object-technical feature data for recording a relationship between the analyzing object data and the technical feature data, and an infringement determining process which uses the claiming data, the related claims-technical feature data, the analyzing object data, the related analyzing object-technical feature data, the plurality of technical feature data and the related technical feature data to determine whether the analyzing object data is infringing on the claiming data.

The above disclosure assists the user in determining whether the plurality of analyzing objects infringe on the plurality of patents but fails to give the judge a reference of equivalent compensation judgments according to different infringing types and prior judgment instances. Therefore, the disclosure is still not so good in use.

### SUMMARY OF THE INVENTION

In view of no reference-aided system developed for judgments of patent infringing cases, the present invention provides a compensation evaluating support system for judgment of patent infringement, which comprises an electronic device respectively and signally connected to an input interface which serves to input an infringement data and an output interface which serves to output a judging result, a database module signally connected to the electronic device and at least including a patent infringement database, a machine-readable format module built in the electronic device and signally connected to the database module for automatically formatting the infringement data and inputting the auto-formatted infringement data into the patent infringement database, a factor screening module built in the electronic device and signally connected to the input interface for inputting a weighting questionnaire data with decision factors via the input interface and analyzing the weighting questionnaire data to generate a weighting coefficient and store it in the database module, a decision support module built in the electronic device and signally connected to the database module and the factor screening module respectively for analyzing the infringement data and the weighting coefficient to generate the judging result, and a decision verification module built in the electronic device and signally connected to the input interface, the database module and the decision support module respectively for inputting a use questionnaire data via the input interface and analyzing the use questionnaire data to update the decision factors.

Preferably, the electronic device is a computer, a notebook, an ipad, a smart phone, or a PDA. The input interface is a keyboard, a mouse, a touching screen, a microphone, a camcorder, or the combination thereof. The output interface is a screen, a printer, a photocopier, a speaker, or the combination thereof.

Preferably, the database module includes a factor weighting database, an analysis and statistics database, a judgment database, a regulation database, a domestic patent database, a foreign patent database, and a patent infringement primal database.

Preferably, the infringement data input to the patent infringement database creates a data report of patent infringement. The data report of patent infringement includes a basic statistics and analysis form of penalties, a ratio table of combined extenuation for several offences, and a ratio table of combined punishment for several offences.

Preferably, the machine-readable format module includes a report pattern, a referral paper pattern, an indictment pattern, and a judgment pattern. The report pattern includes an infringing fact and reason of report templates automatically generated by an aid of a computer. The referral paper pattern includes an infringing fact and reason of referral paper templates. The indictment pattern includes an infringing fact and reason of indictment templates. The judgment pattern includes an infringing fact and reason of judgment templates.

Preferably, the factor screening module includes a secondary module of general binary operation online questionnaire, a secondary module of Delphi binary operation online questionnaire, a secondary module binary analytic-hierarchy-process (AHP) online questionnaire, and a weight-calculating module of decision factors.

Preferably, the decision support module includes a secondary information module, a secondary layout module, a secondary selection module, and a secondary execution module.

Preferably, the secondary selection module includes a judgment of patent validity, a judgment of whether to constitute infringement elements, a general judgment, an aggravated judgment, and a mitigated judgment.

Preferably, the general judgment includes an infringed patent category, a quantity of infringed patent product or an amount of money gained from a patent infringement, maximum and minimum compensations of a patent infringement, a patent infringement type, and an act of an infringer whether to admit and aid investigations. The aggravated judgment includes a conviction due to a criminal background related to infringements, a status of the infringer, a retracted confession, and an evidence destruction. The mitigated judgment includes first offenders, an admission of guilt and an aid to investigations, a submission of adequate bail, an offender who discontinues a crime, an attempted infringement, a surrender, over penalties of original disposals, and a confession in an investigation and during a trial.

Preferably, the decision verification module includes a binary procession secondary module of easy-to-use online questionnaire survey, a binary procession secondary module of usefulness online questionnaire survey, a binary procession secondary module of accuracy online questionnaire survey, and a secondary module of acceptance analysis.

Preferably, a constitution of the decision factors includes a culpability, an infringing record, an infringing weighting punishment and assessment considerations.

Preferably, options of the culpability include a perpetrator type, a patentee infringed number, a patent infringed number, an infringer motivation, infringing ways, infringing situations, and developing stages. Options of the perpetrator type include a profit-seeking enterprise and a non-profit-seeking enterprise. Options of the profit-seeking enterprise include a natural person, a partner, a company, a limited corporation, a limited share corporation and a foreigner-owned business. Options of the non-profit-seeking enterprise include a non-profit-seeking corporation or institution, an academic institution and a government organization. Options of the infringing number include one patent, two patents and more than two patents. Options of the infringing motivation include an intension for seeking profit and intension for imitation. Options of the infringing ways include making, offering for sale, selling, using, and importing. Options of the infringing situations include a final court decision and an infringed patent claimed scope. Options of the developing stages include prototype stage, small-scale production, large-scale production. Options of the infringing record include an infringed patent category, an amount of money gained from a patent infringement, a quantity of infringed patent product, and a patent life cycle. Options of the infringed patent category include an invention patent of a utility patent, a utility model patent and a design patent. Options of the amount of money gained from a patent infringement include a net profit and a gross amount. Options of the infringing weighting punishment include a surrender, an admission of guilt, attitudes after committed crimes, a retracted confession, an evidence destruction, a recidivist, an offender who discontinues a crime, an attempted infringement, a fraudulent transfer, and a confession in an investigation and during a trial. Options of the assessment considerations include an intellectual property quotient, an overall percentile rank and an overall patent rating.

Preferably, the judging result includes a damage compensation amount which is calculated by a formula expression of: An infringed compensation amount=(Estimated property compensation+Non-property damage+Damage difficult to be proved)*Penal damage compensation. The estimated property compensation is calculated either by a profits comparison method, a total profit method, or a total sales proceeds method. The non-property damage is a damage of a business credit. The damage difficult to be proved is a compensation amount assessed by a court. The penal damage compensation is one to three times.

Preferably, the profits comparison method is an expected profit usually attained by executing a patent right minus an attainable profit attained by executing the patent right after being subjected to a victimization. The total profit method is a sale profit minus an administrative expenditure and a financial expenditure. The total sales proceeds method is a market sale quantity of an infringing product times a selling price of each patent product.

One aspect of the present invention is to provide a compensation judgment reference in a patent infringing appeal adapted to judges, prosecutors, lawyers, judicial officials, juridical students, and the public.

Another aspect of the present invention is to provide a reference calculation related to the compensation amount of the patent infringing judgment and assists the judge in making an optimized decision. The present invention prevents misjudgments or unjust judgments due to differences of the personal subjectivity, emotions, or thoughts.

Further another aspect of the present invention is that the present invention can always update data of the system in order to receive the latest reference information and attain a best judgment decision in accordance with different regulations, judgment instances, or changes of data.

### BRIEF DESCRIPTION OF THE DRAWINGS

FIG. 1 is a schematic view showing a system of the present invention;

FIG. 2 is a schematic view showing each constitution of the present decision factors; and

FIG. 3 is a schematic view showing the machine-readable format module of the present invention;

FIG. 4 is a schematic view showing the factor screening module of the present invention;

FIG. 5 is a schematic view showing the decision support module of the present invention;

FIG. 6 is a schematic view showing every option of the present secondary selection module; and

FIG. 7 is a schematic view showing the decision verification module of the present invention.

### DETAILED DESCRIPTION OF THE PREFERRED EMBODIMENTS

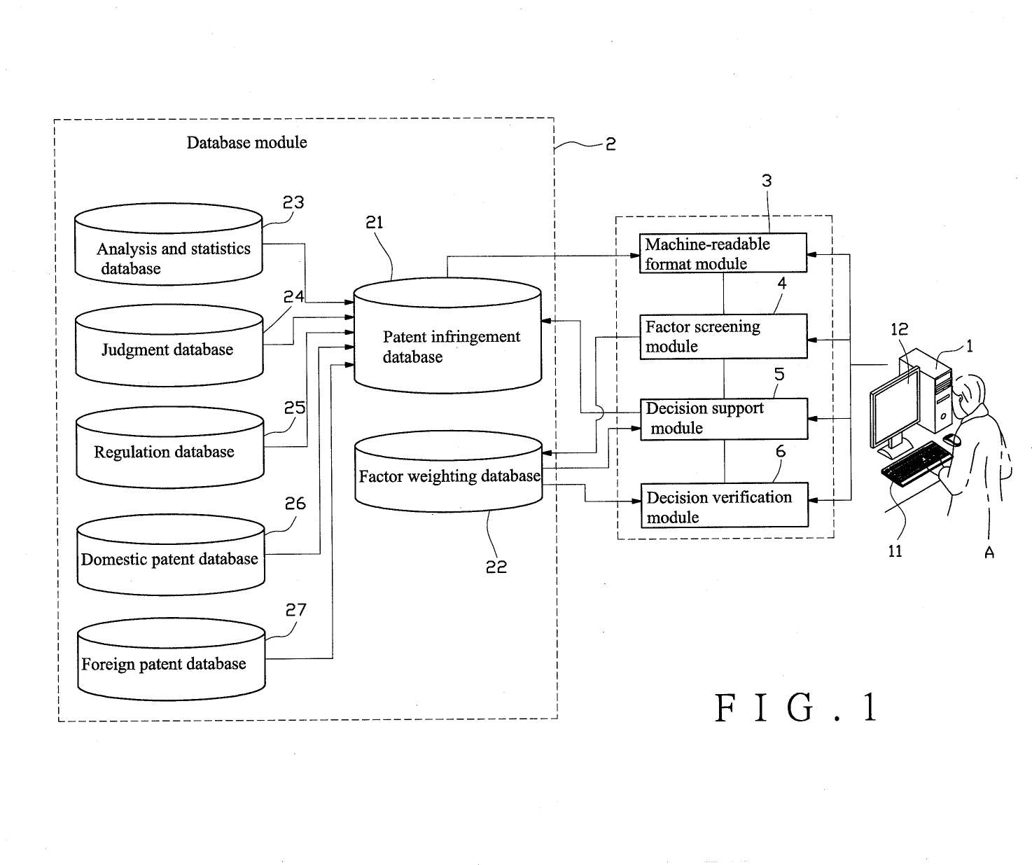

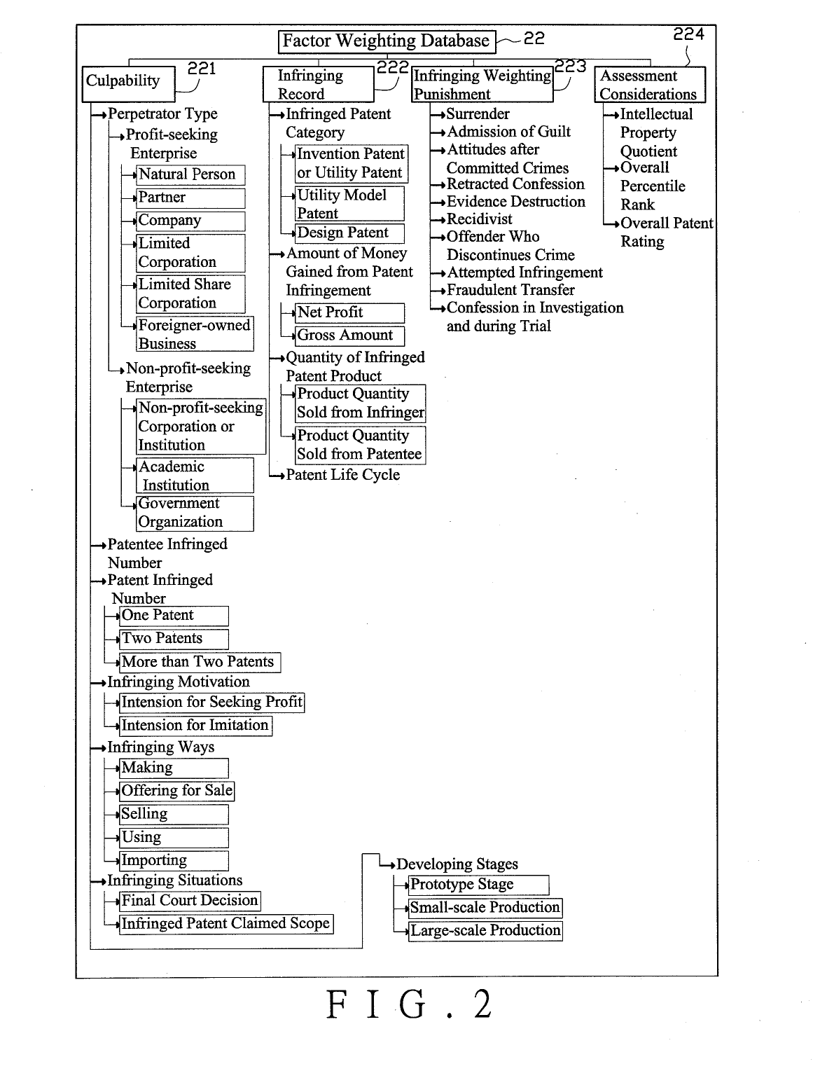

Referring to FIG. 1 and FIG. 2, the present invention comprises an electronic device 1, a database module 2, a machine-readable format module 3, a factor screening module 4, a decision support module 5, and a decision verification module 6. Wherein:

The electronic device 1 is respectively and signally connected to an input interface 11 and an output interface 12. The electronic device 1 is a computer, a notebook, an ipad, a smart phone, or a PDA. The input interface 11 is a keyboard, a mouse, a touching screen, a microphone, a camcorder, or the combination thereof. The output interface 12 is a screen, a printer, a photocopier, a speaker, or the combination thereof. The input interface 11 inputs an infringement data and the output interface 12 outputs a judging result.

The database module 2 is signally connected to the electronic device 1. The database module 2 includes a patent infringement database 21, a factor weighting database 22, an analysis and statistics database 23, a judgment database 24, a regulation database 25, a domestic patent database 26, and a foreign patent database 27. The patent infringement database 21 collects all references input from the analysis and statistics database 23, the judgment database 24, the regulation database 25, the domestic patent database 26, and the foreign patent database 27. The factor weighting database 22 stores decision factors that are effective to compensation judgments. Referring to FIG. 2, the constitution of the decision factors includes a culpability 221, an infringing record 222, an infringing weighting punishment 223, and assessment considerations 224. Wherein options of the culpability 221 include a perpetrator type, a patentee infringed number, a patent infringed number, an infringing motivation, and infringing ways, infringing situations and developing stages. Options of the perpetrator type include a profit-seeking enterprise and a non-profit-seeking enterprise. Options of the profit-seeking enterprise include a natural person, a partner, a company, a limited corporation, a limited share corporation and a foreigner-owned business. Options of the non-profit-seeking enterprise include a non-profit-seeking corporation or institution, an academic institution and a government organization. Options of the patentee infringed number include at least one patentee whose patent is infringed by a third person. Options of the infringing number include one patent, two patents and more than two patents. Options of the infringing motivation include an intension for seeking profit and intension for imitation. Options of the infringing ways include making, offering for sale, selling, using, and importing. Options of the infringing situations include a final court decision and an infringed patent claimed scope. Options of the developing stages include prototype stage, small-scale production, large-scale production. Options of the infringing record 222 include an infringed patent category, an amount of money gained from a patent infringement, a quantity of infringed patent product, and a patent life cycle. Options of the infringed patent category include an invention patent or a utility patent, a utility model patent and a design patent. Options of the amount of money gained from a patent infringement include a net profit and a gross amount. Options of the infringing weighting punishment 223 include a surrender, an admission of guilt, attitudes after committed crimes, a retracted confession, an evidence destruction, a recidivist, an offender who discontinues a crime, an attempted infringement, a fraudulent transfer, and a confession in an investigation and during a trial. Options of the assessment considerations 224 include an intellectual property quotient, an overall percentile rank and an overall patent rating. The analysis and statistics database 23 stores statistics analyzing data related to the patent infringement. The judgment database 24 stores judgments related to the patent infringement. The regulation database 25 stores regulations related to the patent infringement. The domestic patent database 26 stores the information related to the internal patent search and references of the intellectual property office, academic institutions, etc. The foreign patent database 27 stores the information related to the international patent search and references of foreign countries.

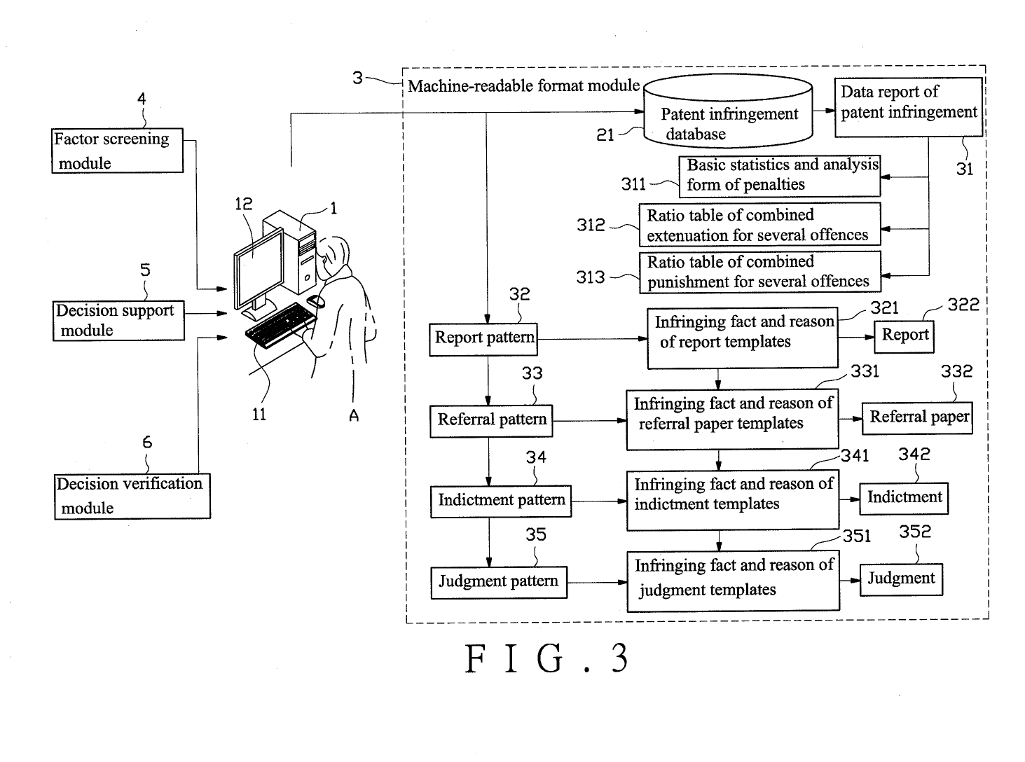

Referring to FIG. 3, the machine-readable format module 3 is built in the electronic device 1 and signally connected to the database module 2 for automatically formatting the infringement data. The machine-readable format module 3 inputs the auto-formatted infringement data into the patent infringement database 21 to create a data report of patent infringement 31. The data report of patent infringement 31 includes a basic statistics and analysis form of penalties 311, a ratio table of combined extenuation for several offences 312, and a ratio table of combined punishment for several offences 313 so as to be easily read. Further, the machine-readable format module 3 includes a report pattern 32, a referral paper pattern 33, an indictment pattern 34, and a judgment pattern 35. The report pattern 32 includes an infringing fact and reason of report templates 321 that is automatically generated by an aid of a computer for establishing a report 322. The referral paper pattern 33 includes an infringing fact and reason of referral paper templates 331 for establishing a referral paper 332. The indictment pattern 34 includes an infringing fact and reason of indictment templates 341 for establishing an indictment 342. The judgment pattern 35 includes an infringing fact and reason of judgment templates 351 for establishing a judgment 352. Wherein, the contents of the infringing fact and reason of report templates 321 are sequentially corresponding to the infringing fact and reason of referral paper templates 331, the infringing fact and reason of indictment templates 341, and the infringing fact and reason of judgment templates 351 in order to facilitate the replication and the use.

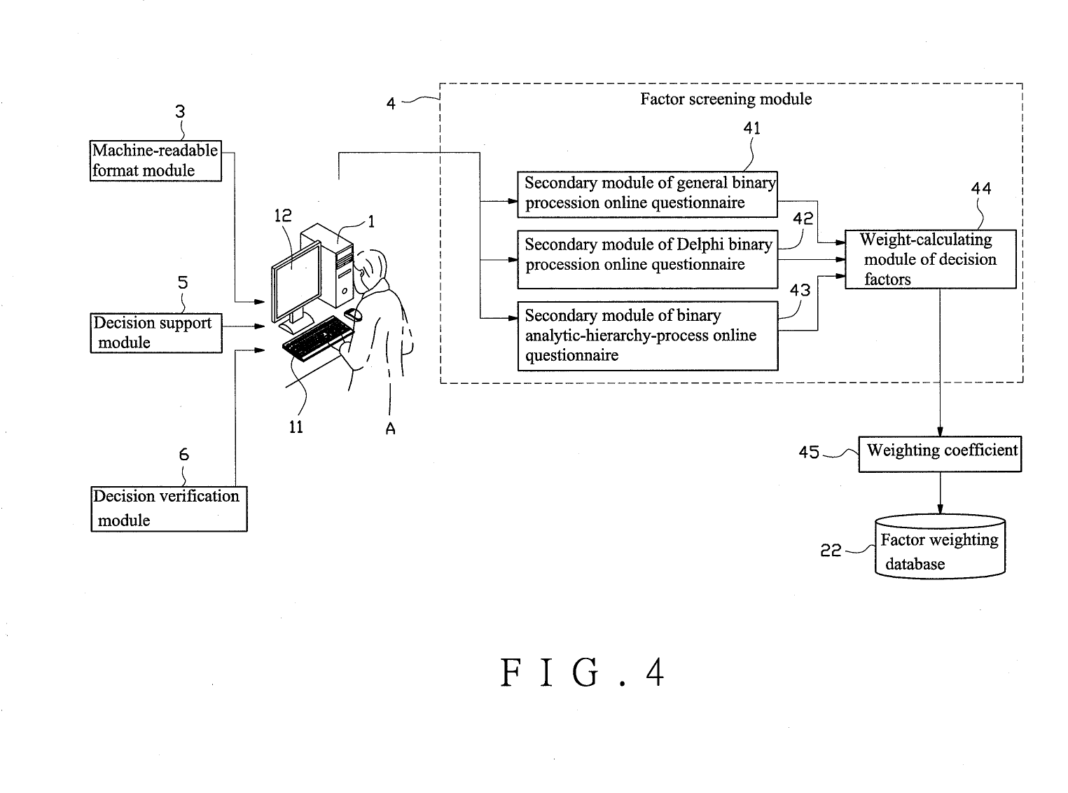

Referring to FIG. 4, the factor screening module 4 is built in the electronic device 1 and signally connected to the input interface 11. The factor screening module 4 inputs a weighting questionnaire data with decision factors via the input interface 11 and analyzes the weighting questionnaire data to generate a weighting coefficient 45 which is then stored in the factor weighting database 22 of the database module 2. The factor screening module 4 includes a secondary module of general binary operation online questionnaire 41, a secondary module of Delphi binary operation online questionnaire 42, a secondary module of binary analytic-hierarchy-process online questionnaire 43, and a weight-calculating module of decision factors 44. Wherein the secondary module of general binary operation online questionnaire 41 includes two options: Yes and No. The secondary module of general binary operation online questionnaire 41, the secondary module of Delphi binary operation online questionnaire 42, and the secondary module of binary analytic-hierarchy-process online questionnaire 43 conduct questionnaires related to the decision factors via a online mode, and the weight-calculating module of decision factors 44 is applied to calculate the weighting coefficient 45 according to the result of the questionnaires.

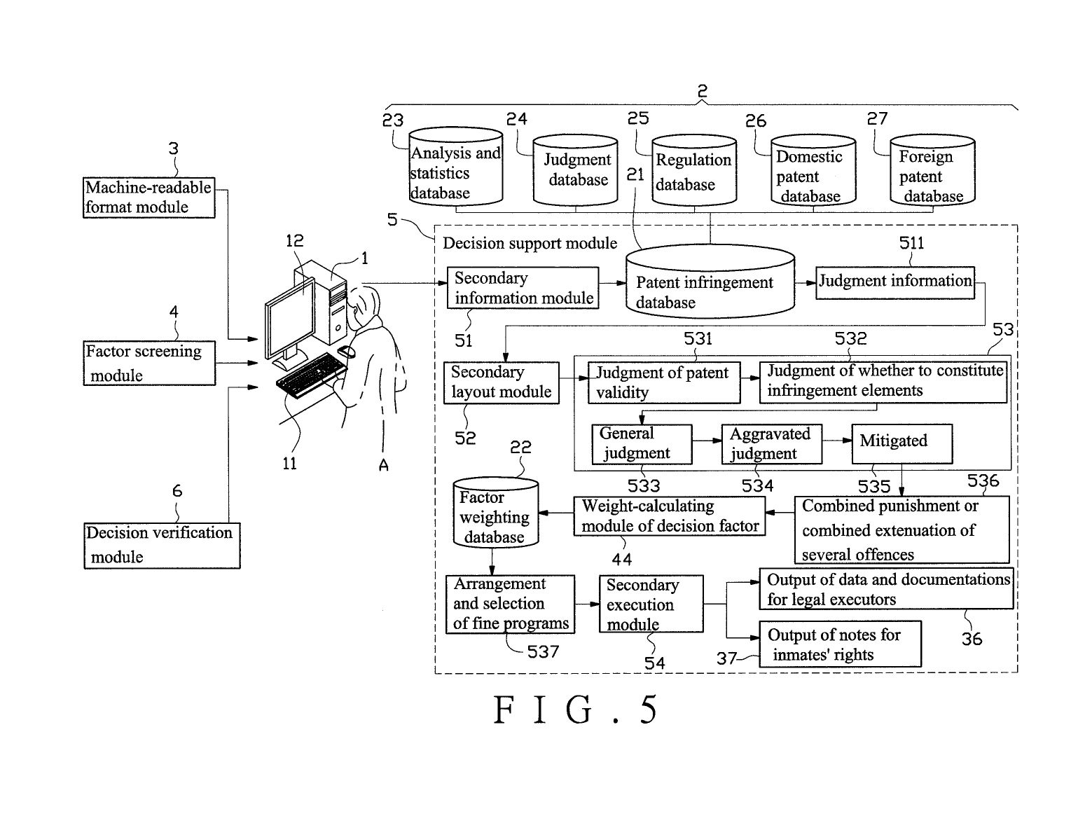

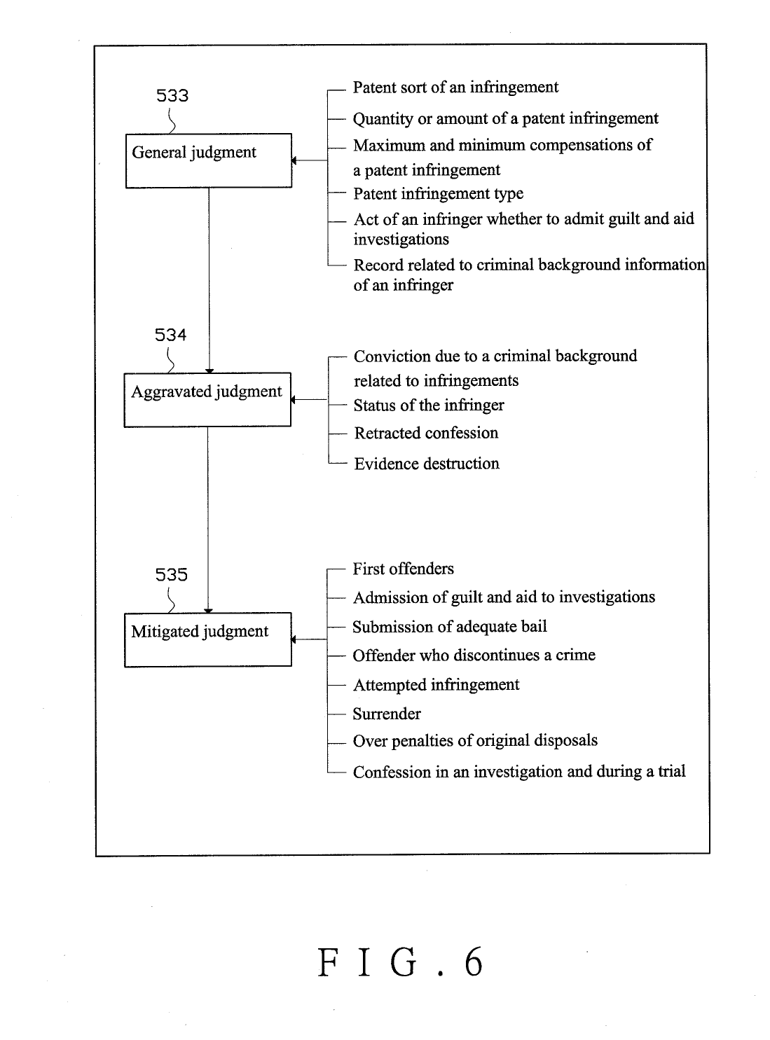

Referring to FIGS. 5-6, the decision support module 5 is built in the electronic device 1 and signally connected to the database module 2 and the factor screening module 4 respectively for analyzing the infringement data and the weighting coefficient 45 to generate the judging result. The decision support module 5 includes a secondary information module 51, a secondary layout module 52, a secondary selection module 53, and a secondary execution module 54. Wherein the secondary information module 51 inputs the infringement data via the input interface 11 and collects references from the patent infringement database 21, the factor weighting database 22, the analysis and statistics database 23, the judgment database 24, the regulation database 25, the domestic patent database 26, and the foreign patent database 27 so as to establish a judgment information 511. The secondary layout module 52 designs a list according to the judgment information 511. The secondary selection module 53 shows options on the list. The secondary selection module 53 includes a judgment of patent validity 531, a judgment of whether to constitute infringement elements 532, a general judgment 533, an aggravated judgment 534, and a mitigated judgment 535. Wherein the general judgment 533 includes an infringed patent category, quantity of infringed patent product or amount of money gained from a patent infringement, maximum and minimum compensations of a patent infringement, a patent infringement type, an act of an infringer whether to admit guilt or aid investigations, and a record related to criminal background information of an infringer. The aggravated judgment 534 includes a conviction due to a criminal background related to infringements, a status of the infringer, a retracted confession, and an evidence destruction. The mitigated judgment 535 includes first offenders, an admission of guilt and an aid to investigations, a submission of adequate bail, an offender who discontinues a crime, an attempted infringement, a surrender, over penalties of original disposals, and a confession in an investigation and during a trial. Further, options of combination punishment or combined extenuation of several offences 536 can be selected additionally. Then, according to the weighting coefficients 45 provided by the weight-calculating module of decision factors 44 and the factor weighting database 22, options of an arrangement and selection of fine programs 537 are established. The secondary execution module 54 combines the above information to create the judging result. The judging result includes an output of data and documentations for legal executors 36 and an output of notes for inmates' rights 37. Wherein, the data and documentations for legal executors 36 at least include the report 322, the referral paper 332, the indictment 342, or the judgment 352. The content of the judgment 352 includes a damage compensation amount which is calculated as the following formula:

infringed compensation amount=(estimated property compensation+non-property damage+damage difficult to be proved)×penal damage compensation.

The estimated property compensation is calculated either by a profits comparison method, a total profit method, or a total sale proceeds method. The profits comparison method is an expected profit usually attained by executing a patent right minus an attainable profit attained by executing the patent right after being subjected to a victimization. The total profit method is a sale profit minus an administrative expenditure and a financial expenditure. The total sale proceeds method is a market sale quantity of an infringing product times a selling price of each patent product.

The non-property damage is a damage of a business credit. When the damage is too difficult to be proved, the court will assess a compensation amount. The penal damage compensation is one to three times.

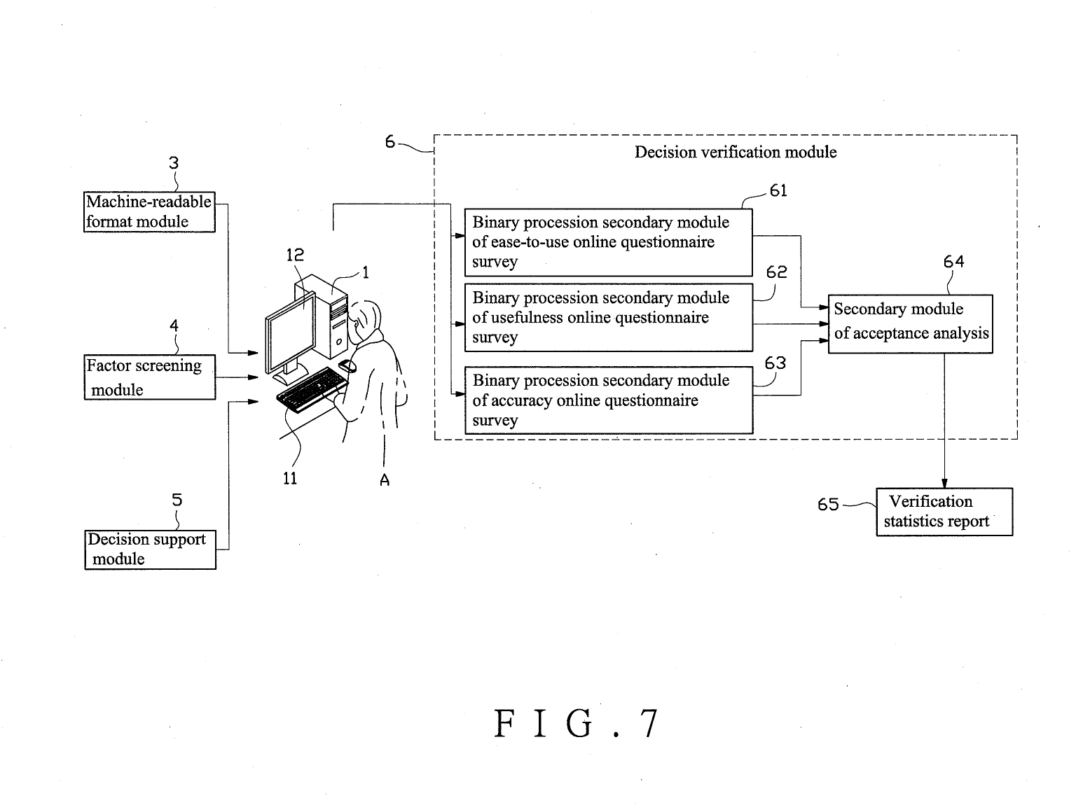

Referring to FIG. 7, the decision verification module 6 is built in the electronic device 1 and signally connected to the input interface 11, the database module 2 and the decision support module 5 respectively. The decision verification module 6 includes a binary procession secondary module of easy-to-use online questionnaire survey 61, a binary procession secondary module of usefulness online questionnaire survey 62, a binary procession secondary module of accuracy online questionnaire survey 63, and a secondary module of acceptance analysis 64. The decision verification module 6 inputs a use questionnaire data via the input interface 11 and applies the binary procession secondary module of easy-to-use online questionnaire survey 61, the binary procession secondary module of usefulness online questionnaire survey 62, and the binary procession secondary module of accuracy online questionnaire survey 63 to analyze the use questionnaire data, which is thence collected and judged by the secondary module of acceptance analysis 64 to attain a verification statistics report 65 and update the decision factors accordingly.

Referring to FIG. 1 and FIG. 5, while executing the system to aid the compensation calculation/evaluation of the patent infringement, users “A”, such as judges, prosecutors, lawyers, judicial officials, juridical students, and the public, turn on the electronic device 1 and input each of infringement data of an infringer via the input interface 11. The secondary information module 51 of the decision support module 5 collects the references related to the infringement data from the patent infringement database 21, the factor weighting database 22, the analysis and statistics database 23, the judgment database 24, the regulation database 25, the domestic patent database 26, and the foreign patent database 27 of the database module 2. Therefore, the judgment information 511 is generated. The secondary layout module 52 provides a list including options for users “A” to choose, namely the judgment of patent validity 531, the judgment of whether to constitute infringement elements 532, the general judgment 533, the aggravated judgment 534, and the mitigated judgment 535. Further, the weighting coefficients 45 from the weight-calculating module of decision factors 44 and the factor weighting database 22 are computed via a weighted calculation to create options of the arrangement and selection of fine programs 537 for users “A” to select. Referring to FIG. 3, Users “A” can select the report pattern 32, the referral paper pattern 33, the indictment pattern 34, and the judgment pattern 35 according to their demands. Finally, the judging result is established via the secondary execution module 54. The judging result generates the data and documentations for legal executors 36 and notes for inmates' rights 37 according to demands of users “A”. Wherein, the data and documentations for legal executors 36 at least includes the report 321, the referral paper 331, the indictment 341, or the judgment 351. The content of the judgment 351 includes a calculation of a compensation amount as a reference of the judgment related to the compensation part.

Referring to FIG. 4, by means of the secondary module of general binary operation online questionnaire 41, the secondary module of Delphi binary operation online questionnaire 42, and the secondary module of binary analytic-hierarchy-process online questionnaire 43 of the factor screening module 4, the questionnaires with regard to the culpability 221, the infringing record 222, the infringing weighting punishment 223, and the assessment considerations 224 of the decision factors can be carried out online for a survey, directing to the people familiar with affairs of the patent infringement, such as judges, professionals, scholars, professors, etc. After completing the survey, the weight-calculating module of decision factors 44 calculates the result of the survey and updates the weighting coefficients 45 periodically so as to receive the latest information at any time.

Referring to FIG. 7, by means of the binary procession secondary module of easy-to-use online questionnaire survey 61, the binary procession secondary module of usefulness online questionnaire survey 62, the binary procession secondary module of accuracy online questionnaire survey 63, and the secondary module of acceptance analysis 64 of the decision verification module 6, the present invention applies the online questionnaires to inspect the satisfaction of all users “A” after using, which are then collected and analyzed by the secondary module of acceptance analysis 64 to attain the verification statistics report 65. Therefore, the decision factors can be updated at any time for the present system to receive the latest information.

While the present invention has been described in its preferred embodiments, it is understood that the afore description has been given only by way of example and that numerous changes in the details of construction, fabrication and use to make further variations, alternatives and modifications, including the combination and arrangement of parts, may be made without departing from the scope of the present invention.

What is claimed is:

1. A compensation evaluating support system for judgment of patent infringement comprising:
an electronic device, said electronic device being signally connected to an input interface and an output interface respectively, said input interface being provided for inputting an infringement data and said output interface being provided for outputting a judging result;
a database module, said database module being signally connected to said electronic device, said database module at least including a patent infringement database;
a machine-readable format module, said machine-readable format module being built in said electronic device and signally connected to said database module for automatically formatting said infringement data, said machine-readable format module inputting said auto-formatted infringement data to said patent infringement database;
a factor screening module, said factor screening module being built in said electronic device and signally connected to said input interface, said factor screening module inputting a weighting questionnaire data with decision factors via said input interface and analyzing said weighting questionnaire data to generate a weighting coefficient which is thence stored in said database module;
a decision support module, said decision support module being built in said electronic device and signally connected to said database module and said factor screening module respectively so as to analyze said infringement data and said weighting coefficient and create said judging result accordingly; and
a decision verification module, said decision verification module being built in said electronic device and signally connected to said input interface, said database module, and said decision support module respectively, said decision verification module inputting a use questionnaire data via said input interface and analyzing said use questionnaire data to update said decision factors.

2. The system as claimed in claim 1, wherein said electronic device is a computer, a notebook, an ipad, a smart phone, or a PDA, said input interface is a keyboard, a mouse, a touching screen, a microphone, a camcorder, or a combination thereof, said output interface is a screen, a printer, a photocopier, a speaker, or a combination thereof.

3. The system as claimed in claim 1, wherein said database module includes a factor weighting database, an analysis and statistics database, a judgment database, a regulation database, a domestic patent database, a foreign patent database, and a patent infringement primal database.

4. The system as claimed in claim 1, wherein said infringement data input to said patent infringement database creates a data report of patent infringement, said data report of patent infringement includes a basic statistics and analysis form of penalties, a ratio table of combined extenuation for several offences, and a ratio table of combined punishment for several offences.

5. The system as claimed in claim 1, wherein said machine-readable format module includes a report pattern, a referral paper pattern, an indictment pattern, and a judgment pattern, said report pattern includes an infringing fact and reason of report templates automatically generated via an aid of a computer, said referral paper pattern includes an infringing fact and reason of referral paper templates, said indictment pattern includes an infringing fact and reason of indictment templates, and said judgment pattern includes an infringing fact and reason of judgment templates.

6. The system as claimed in claim 1, wherein said factor screening module includes a secondary module of general binary operation online questionnaire, a secondary module of Delphi binary operation online questionnaire, a secondary module of binary analytic-hierarchy-process online questionnaire, and a weight-calculating module of decision factors.

7. The system as claimed in claim 1, wherein said decision support module includes a secondary information module, a secondary layout module, a secondary selection module, and a secondary execution module.

8. The system as claimed in claim 7, wherein options of said secondary selection module include a judgment of patent validity, a judgment of whether to constitute infringement elements, a general judgment, an aggravated judgment, and a mitigated judgment.

9. The system as claimed in claim 8, wherein said general judgment includes an infringed patent category, quantity of infringed patent product or amount of money gained from a patent infringement, maximum and minimum compensations of a patent infringement, a patent infringement type, and an act of an infringer whether to admit and aid investigations, said aggravated judgment includes a conviction due to a criminal background related to infringements, a status of said infringer, a retracted confession, and an evidence destruction, said mitigated judgment includes first offenders, an admission of guilt and an aid to investigations, a submission of adequate bail, an offender who discontinues a crime, an attempted infringement, a surrender, over penalties of original disposals, and a confession in an investigation and during a trial.

10. The system as claimed in claim 1, wherein said decision verification module includes a binary procession secondary module of easy-to-use online questionnaire survey, a binary procession secondary module of usefulness online questionnaire survey, a binary procession secondary module of accuracy online questionnaire survey, and a secondary module of acceptance analysis.

11. The system as claimed in claim 1, wherein a constitution of said decision factors includes a culpability, an infringing record, an infringing weighting punishment and an assessment considerations.

12. The system as claimed in claim 11, wherein options of said culpability include a perpetrator type, a patentee infringed number, a patent infringed number, an infringer motivation, infringing ways, infringing situations, and developing stages; options of the perpetrator type include a profit-seeking enterprise and a non-profit-seeking enterprise; options of the profit-seeking enterprise include a natural person, a partner, a company, a limited corporation, a limited share corporation and a foreigner-owned business; options of the non-profit-seeking enterprise include a non-profit-seeking corporation or institution, an academic institution and a government organization; options of the patentee infringed number include at least one patentee whose patent is infringed by an infringer; options of the infringing number include one patent, two patents and more than two patents; options of the infringing motivation include an intension for seeking profit and intension for imitation; options of the infringing ways include making, offering for sale, selling, using, and importing; options of the infringing situations include a final court decision and an infringed patent claimed scope; options of the developing stages includes prototype stage, small-scale production, large-scale production; options of the infringing record include an infringed patent category, an amount of money gained from a patent infringement, a quantity of infringed patent product, and a patent life cycle; options of the infringed patent category include an invention patent or a utility patent, a utility model patent and a design patent; options of the amount of money gained from a patent infringement include a net profit and a gross amount; options of the infringing weighting punishment include a surrender, an admission of guilt, attitudes after committed crimes, a retracted confession, an evidence destruction, a recidivist, an offender who discontinues a crime, an attempted infringement, a fraudulent transfer, and a confession in an investigation and during a trial; options of the assessment considerations include an intellectual property quotient, an overall percentile rank and an overall patent rating.

13. The system as claimed in claim 1, wherein said judging result includes a damage compensation amount which is calculated by a sum of an estimated property compensation, a non-property damage, and a damage difficult to be proved times a penal damage compensation, with an expression of:
infringed compensation amount=(estimated property compensation+non-property damage+damage difficult to be proved)×penal damage compensation;
said estimated property compensation is calculated either by a profits comparison method, a total profit method, or a total sales proceeds method, said non-property damage is a damage of a business credit, said damage difficult to be proved is a compensation amount assessed by a court, and said penal damage compensation is one to three times.

14. The system as claimed in claim 13, wherein said profits comparison method is an expected profit usually attained by executing a patent right minus an attainable profit attained by executing said patent right after being subjected to a victimization, said total profit method is a sale profit minus an administrative expenditure and a financial expenditure, and said total sales proceeds method is a market sale quantity of an infringing product times a selling price of each patent product.
